(19) United States
(12) Patent Application Publication
(10) Pub. No.: US 2003/0208946 A1
(43) Pub. Date: Nov. 13, 2003

(54) Fishing rod

(76) Inventor: Igor Rozenberg, Concord (CA)

Correspondence Address: BERESKIN AND PARR, SCOTIA PLAZA, 40 KING STREET WEST-SUITE 4000 BOX 401, TORONTO, ON, M5H 3Y2, CA

(21) Appl. No.: 10/139,387

(22) Filed: May 7, 2002

(51) Int. Cl. A01K 85/01; A01K 93/00; A01K 97/12

(52) U.S. Cl. 43/17

(57) ABSTRACT

A fishing rod includes a stable arm and a moveable arm. The stable arm has a first stable arm end and a second stable arm end. The moveable arm has a first moveable arm end and a second moveable arm end. The moveable arm is pivotally coupled to the stable arm and the second moveable arm end is biased to a first position remote from the second stable arm end.

### FIELD OF THE INVENTION

This invention relates to the field of fishing rods, with particular but by no means exclusive application to ice fishing rods.

### BACKGROUND

Ice fishing rods tend to be shorter in length than standard fishing rods, and tend to be prone to breaking. Ice fishing rods also commonly use a float or bob on the fishing line to provide a visual cue of a fish on the hook on the end of the fishing line. However, the float can freeze in the ice, preventing it from signalling the presence of a fish and potentially causing the fisherman to lose the fish.

Accordingly, the inventor has recognized the need for an improved fishing rod to address these disadvantages.

### SUMMARY OF THE INVENTION

The fishing rod of the present invention includes a stable arm, a moveable arm and a fishing line guide coupled to the moveable arm. The stable arm has a first stable arm end and a second stable arm end. The moveable arm has a first moveable arm end and a second moveable arm end. The first moveable arm end is coupled to the stable arm and the second moveable arm end is biased to a first position remote from the second stable arm end. The fishing line guide is positioned proximate the second moveable arm end.

### BRIEF DESCRIPTION OF THE DRAWINGS

The present invention will now be described, by way of example only, with reference to the following drawings, in which like reference numerals refer to like parts and in which:

FIG. 1 is a side view of a fishing rod, made in accordance with the present invention;

FIG. 2 is a side view of components of the fishing rod of FIG. 1;

FIG. 3A is a top perspective view of a first type of line guide of the fishing rod of FIG. 1;

FIG. 3B is a side perspective view of a second type of line guide of the fishing rod of FIG. 1;

FIG. 3C is a bottom rearward perspective view of a joining member of the fishing rod of FIG. 1;

FIG. 3D is a bottom perspective view of a butt end of the fishing rod of FIG. 1; and

FIG. 3E is an end view of the central cylinder of the fishing rod of FIG. 1.

### DETAILED DESCRIPTION OF THE INVENTION

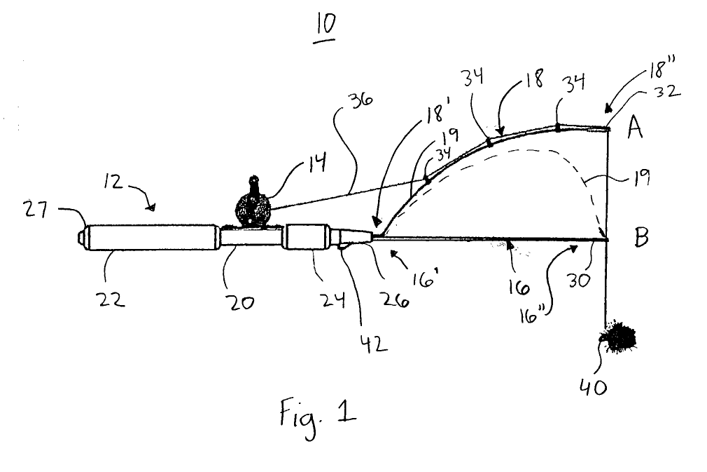

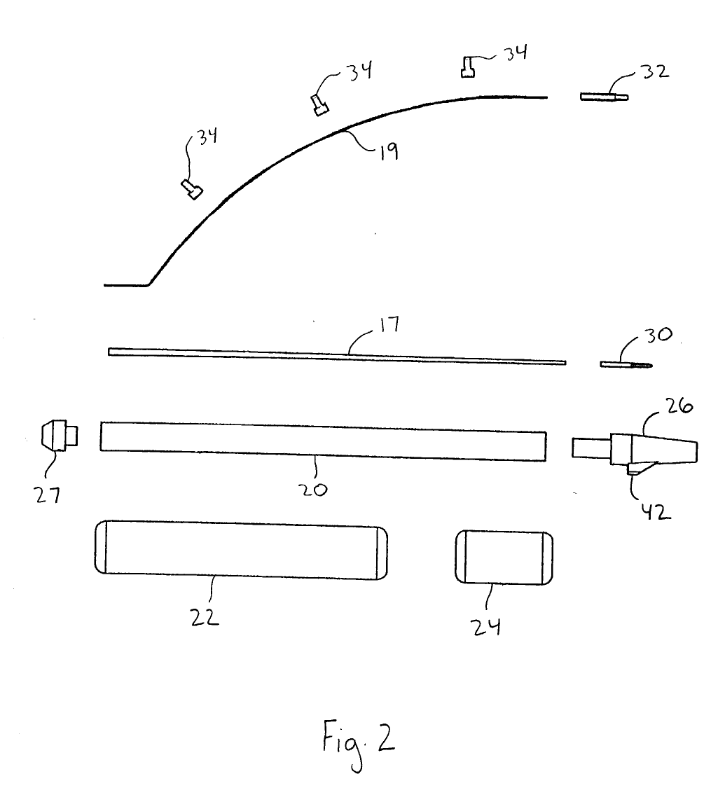

Referring simultaneously to FIGS. 1, 2 and 3A-3E, illustrated therein is a fishing rod, referred to generally as 10, made in accordance with the present invention. The fishing rod 10 comprises a handle 12, a fishing line reel 14, a stable arm 16 and a moveable arm 18.

The handle 12 may comprise a central cylinder 20 over which may be mounted a first grip member 22 and a second grip member 24. The grip members 22, 24 may be formed of rubber, durable foam or other material which facilitates the user's gripping of the handle 12. The reel 14 may be screwed or otherwise mounted to the central cylinder 20. A joining member 26 is preferably inserted into and fixed to the front end of the shaft 20. A knob or butt end 27 may be inserted into and fixed to the end of the handle 12.

The stable arm 16 may be a shaft 17 of fibreglass or graphite composite or other appropriate material as may be used in standard fishing rods having a first end 16′ mounted to and typically received into the joining member 26. The second end 16″ of the stable arm 16 may include a line guide 30 fixed to the shaft.

The main body 19 of the moveable arm 18 will typically be formed of alloy 301 stainless steel or other resilient and sufficiently strong material. The main body 19 of the moveable arm 18 may be flat and formed into an arc, to achieve the desired resiliency. The first end 18′ of the moveable arm 18 may be mounted to and received by the joinging member 26, or otherwise coupled to and in pivotal relationship with the stable arm 16. The second end 18″ of the moveable arm 18 is biased with a biasing force to a first position A remote from the second stable arm end 16″.

The moveable arm includes a line guide 32 attached to or otherwise positioned at the free, second moveable arm end 18″. The moveable arm 18 may also have other eyelets or line guides 34 mounted to it. The line guides 34 may be designed with a passage through which the moveable arm 18 may slide, in order to mount the guides 34 to the arm 18 and position them along the arm 18. As can be seen, fishing line 36 may be fed from the reel 14 through the line guides 34, 32 and 30. As will be understood, the reel 14 retains and dispenses the fishing line 36. A fishing lure 40 or other hook may be attached to the free end of the fishing line 36. The joining member 26 may include a hook receiver 42 configured to receive the hook of a lure 40 and hold the lure in place when the fishing rod 10 is not in use.

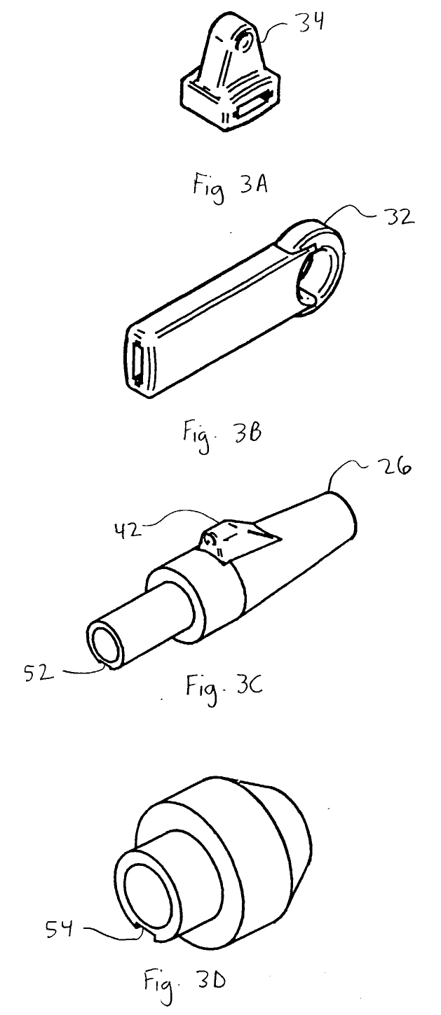

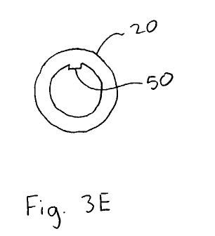

As shown in FIG. 3E, the central cylinder 20 may be provided with a ridge 50 which may be formed of the same material as the cylinder 20, or which may be made of metal or other strengthening material and mounted to the cylinder 20. The ridge 50 may run the length of the cylinder 20, and may be positioned on the interior of the cylinder 20. While the ridge 50 may strengthen the cylinder 20, the ridge 50 may also serve to align the joining member 26 and the butt end 27, which may be provided with corresponding grooves 52, 54 to engage the ridge 50.

In use, when there is no tension on the fishing line 36, the second moveable arm end 18″ (and line guide 32) remains biased to the first position A remote from the second stable arm end 16″ (and line guide 30). When a fish strikes the lure 40, tension is put on the fishing line 36, overcoming the biasing force and causing the second moveable arm end 18″ (as shown in dotted outline in FIG. 1) to deflect towards a second position B, with the second moveable arm end 18″ in contact with the stable arm 16.

When the second moveable arm end 18″ is in the second position B, the moveable arm 18 provides reinforcement to the stable arm 16, and thereby increases the force required to break the stable arm 16. Additionally, as will be understood, the deflection of the moveable arm 18 towards the second position B provides a visual indicator to the user that a fish has struck the lure 40.

In cases of partial fish strikes on the lure 40, the moveable arm 18 may only move partway towards the second position B, and providing a visual indication of the presence of a fish.

Thus, while what is shown and described herein constitutes preferred embodiments of the subject invention, it should be understood that various changes can be made without departing from the subject invention, the scope of which is defined in the appended claims.

I claim:

1. A fishing rod, comprising:
(a) a stable arm having a first stable arm end and a second stable arm end; and
(b) a moveable arm having a first moveable arm end and a second moveable arm end, wherein the moveable arm is pivotally coupled to the stable arm and wherein the second moveable arm end is biased to a first position remote from the second stable arm end.

2. The fishing rod of claim 1, further comprising a fishing line guide coupled to the moveable arm and positioned proximate the second moveable arm end.

3. The fishing rod of claim 2, further comprising fishing line and a fishing line retaining mechanism.

4. The fishing rod of claim 3, wherein the second moveable arm end is adapted to pivot toward a second position proximate the second stable arm end upon tension being applied to the fishing line.

5. The fishing rod of claim 1 further comprising a handle, and wherein the handle is coupled to the stable arm proximate the first stable arm end.

6. The fishing rod of claim 2, wherein the fishing line storing mechanism comprises a fishing reel.

7. The fishing rod of claim 3, wherein the fishing reel is mounted to the handle.

8. The fishing rod of claim 1, wherein the second moveable arm end is pivotable to a second position, wherein at the second position the second moveable arm end is in contact with the stable arm.

9. The fishing rod of claim 1, further comprising at least one eyelet mounted to the moveable arm.

10. The fishing rod of claim 1, wherein the moveable arm comprises alloy 301 stainless steel.

11. The fishing rod of claim 1, wherein the stable arm comprises one of fiberglass and graphite composite.
